(19) United States
(12) Patent Application Publication
(10) Pub. No.: US 2024/0412482 A1
(43) Pub. Date: Dec. 12, 2024

(54) METHOD, APPARATUS, DEVICE AND STORAGE MEDIUM FOR INTERACTION

(71) Applicant: Beijing Bytedance Network Technology Co., Ltd., Beijing (CN)

(72) Inventors: Yitong WANG, Beijing (CN); Yu GAO, Beijing (CN); Junta WU, Beijing (CN); Jianbo YAN, Beijing (CN); Guojin HE, Beijing (CN); Linjie XING, Beijing (CN)

(21) Appl. No.: 18/699,843

(22) PCT Filed: Sep. 26, 2022
(86) PCT No.: PCT/CN2022/121211

§ 371 Date: Apr. 9, 2024

(30) Foreign Application Priority Data
Oct. 9, 2021 (CN) 202111176740.7

(51) Int. Cl. G06V 10/74; A63F 13/46; A63F 13/798; G06V 10/40; G06V 10/82; G06V 20/20

(52) U.S. Cl. CPC G06V 10/74; A63F 13/46; A63F 13/798; G06V 10/40; G06V 10/82; G06V 20/20

(57) ABSTRACT

The disclosure discloses a method, an apparatus, a device, and a storage medium for interaction. The method of interaction includes: in response to detecting that a first user enters a virtual room, displaying a shooting task list in the virtual room; the shooting task list containing a plurality of shooting tasks, and each shooting task carries task information; obtaining, for the shooting task, an image taken by the first user based on the task information carried by the shooting task; performing a feature extraction on the image to obtain feature information; and comparing the feature information with the task information, and determining that the shooting task is completed if the feature information matches the task information.

This application claims priority to Chinese Patent Application No. 202111176740.7 filed to the Chinese Patent Office on Oct. 9, 2021, which is hereby incorporated by reference in its entirety.

### FIELD

The present disclosure relates to the field of computer network technology, for example, to a method, an apparatus, a device, and a storage medium for interaction.

### BACKGROUND

Intelligent terminals have become indispensable tools in lives of people. Users may interact with intelligent terminals for social activities, for example, play multiplayer online games through an intelligent terminal.

In the related art, when a user is playing the multiplayer online game, the interaction between the user and the terminal device may only be realized by controlling a character of the game, therefore most of the user attention is focused on the character and cannot pay attention to the current scene situation. That is, only the interaction between the user and the terminal device may be realized, while the interaction between the terminal device and the scene cannot be realized, so that the interaction pattern with the terminal device is single.

### SUMMARY

The present disclosure provides a method, an apparatus, a device and a storage medium for interaction. An interaction between the terminal device and an offline scene may be realized, and the diversity of the interaction pattern with the terminal device may be increased.

The present disclosure provides a method of interaction, and the method comprises:
in response to detecting that a first user enters a virtual room, displaying a shooting task list in the virtual room; wherein the shooting task list contains a plurality of shooting tasks, and each shooting task carries task information;
obtaining, for the shooting task, an image taken by the first user based on the task information carried by the shooting task;
performing a feature extraction on the image to obtain feature information; and
comparing the feature information with the task information, and determining that the shooting task is completed if the feature information matches the task information.

The present disclosure also provides an apparatus for interaction, and the apparatus comprises:
a task list displaying module configured to, in response to detecting that a first user enters a virtual room, display a shooting task list in the virtual room; wherein the shooting task list contains a plurality of shooting tasks, and each shooting task carries task information;
an image obtaining module configured to obtain, for the shooting task, an image taken by the first user based on the task information carried by the shooting task;
a feature information obtaining module configured to perform a feature extraction on the image to obtain feature information; and
an information comparing module configured to compare the feature information with the task information, and determine that the shooting task is completed if the feature information matches the task information.

The present disclosure also provides an electronic device, and the electronic device comprises:
at least one processing device;
a storage device configured to store at least one program;
the at least one program, when executed by the at least one processing device, causes the at least one processing device to perform the method of interaction mentioned above.

The present disclosure also provides a computer-readable medium, the computer-readable medium storing a computer program, wherein the program, when executed by a processing device, performs the method of interaction mentioned above.

The present disclosure also provides a computer program product. The computer program product, comprising a computer program carried on a computer-readable medium, the computer program comprising program code for performing the method of interaction mentioned above.

### BRIEF DESCRIPTION OF THE DRAWINGS

FIG. 1 is a flowchart of a method of interaction provided in the embodiments of the present disclosure;

FIG. 2 is an example diagram of a task interface provided in the embodiments of the present disclosure;

FIG. 3 is an example diagram of a further task interface provided in the embodiments of the present disclosure;

FIG. 4 is a process diagram of jumping from a task list to a task interface provided in the embodiments of the present disclosure;

FIG. 5 is a schematic diagram of an interaction provided in the embodiments of the present disclosure;

FIG. 6 is a schematic diagram of the structure of an apparatus for interaction provided in the embodiments of the present disclosure; and

FIG. 7 is a schematic diagram of the structure of an electronic device provided in the embodiments of the present disclosure.

### DETAILED DESCRIPTION

The following will describe the embodiments of the present disclosure with reference to the accompanying drawings. Although some embodiments of the present disclosure are shown in the drawings, the present disclosure can be implemented in various forms, and these embodiments are provided for understanding the present disclosure. The drawings and embodiments of the present disclosure are for illustrative purposes only.

The multiple steps described in the method implementation of the present disclosure may be executed in different orders and/or in parallel. In addition, the method implementation may include additional steps and/or omit a shown step. The scope of the present disclosure is not limited in this regard.

The term “comprising” and its variations as used herein are open to comprise, i.e. “comprising but not limited to”. The term “based on” means “at least partially based on”. The term “one embodiment” means “at least one embodiment”; the term “another embodiment” means “at least one additional embodiment”; and the term “some embodiments” means “at least some embodiments”. Relevant definitions of other terms will be given in the following description.

The concepts of “first” and “second” mentioned in the present disclosure are only used to distinguish different apparatuses, modules, or units, and are not used to limit the order or interdependence of the functions performed by these apparatuses, modules, or units.

The modifications of “one” and “multiple” mentioned in the present disclosure are illustrative and not restrictive. Those skilled in the art should understand that unless otherwise indicated in the context, they should be understood as “one or more”.

Messages or names of the messages exchanged between a plurality of apparatuses in the implementations of the present disclosure are for illustrative purposes only and are not intended to limit the scope of these messages or information.

In the related art, when the user is playing the multiplayer online game, the interaction between the user and the terminal device may only be achieved by controlling the character of the game, therefore most of the user attention is focused on the character and cannot pay attention to the current scene situation. In order to realize the interaction between the terminal device and the scene, and to shorten the distance between game participants in the real world through online games, the present disclosure proposes a method of interaction.

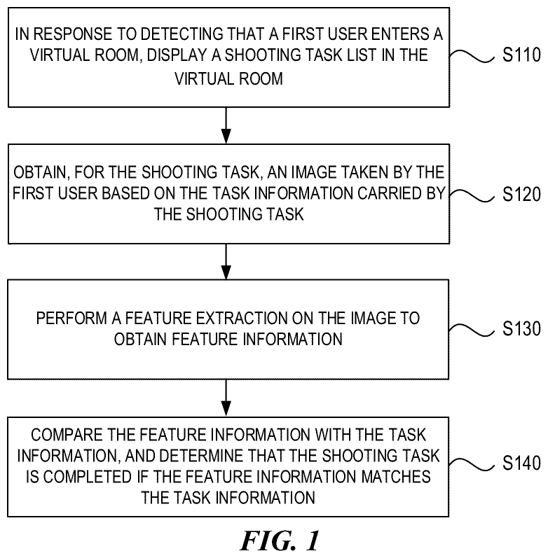

FIG. 1 is a flowchart of a method of interaction provided in the embodiments of the present disclosure. The present embodiment may be applied to a case of interaction between a terminal device and a scene. The method may be performed by an apparatus for interaction which may be composed of hardware and/or software, and may generally be integrated into a device with interactive functions. The device may be an electronic device such as a server, a mobile terminal, or a server cluster. As shown in FIG. 1, the method includes:
110. in response to detecting that a first user enters a virtual room, displaying a shooting task list in the virtual room.

The shooting task list contains a plurality of shooting tasks, and each shooting task carries task information. The task information may be associated with an offline scene (for example, a shopping mall, a school, a tourist attraction, or the like).

In this embodiment, the first user may be a game participant entering the virtual room and the first user may be one person or multiple people. The virtual room may be a game-exclusive room created by an organizer, which may be customized by the organizer. For example, the interests of game participants may be collected and the game-exclusive room may be created based on their interests. The first user may enter the virtual room in various ways, such as by entering a virtual room number, clicking on an invitation link, or the like.

For example, if an organizer A creates a virtual room A and an organizer B creates a virtual room B, personnel participating in a team building activity organized by the organizer A may enter the virtual room A for shooting tasks; personnel participating in a team building activity organized by the organizer B may enter the virtual room B for shooting tasks.

In this embodiment, the user may log in to a game application (APP) installed on the terminal device, and open the mobile APP. If the user logs in to the APP for the first time, a user registration interface is entered. After the user completes the registration, the mobile APP is logged in again. If the user already has a mobile APP account, a game homepage is logged in and a game identity is to be selected. There are two identities to choose from: the organizer or the participant. Here, the participant identity is selected, the virtual room is entered, and a challenge is participated according to the task set in the room.

In response to detecting that the first user enters the virtual room, the terminal device displays the shooting task list set in the virtual room, and the first user may perform a shooting operation on the target scene based on the task information carried by each task shooting task in the shooting task list.

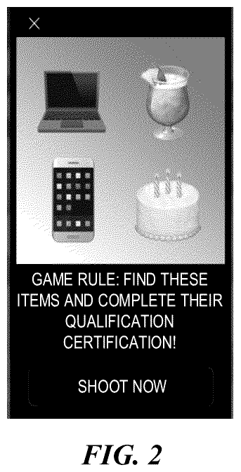

FIG. 2 is an example diagram of a task interface provided in the embodiments of the present disclosure. As shown in FIG. 2, four item images are displayed in the interface, and the task information specified in the shooting task is: “find these items and complete their qualification certification!”
120: For each shooting task, obtain an image taken by the first user based on the task information.

The shooting task may be set by the game organizer, which may correspond to a plurality of shooting types, thus forming a variety of gameplay and increasing interest. For example, it may be a shooting type of task (for example, an indoor treasure hunting task that connects people and objects or a check-in challenge task that connects people and scenery); a video type of task (for example, the user body needs to locate at a designated point on the screen within a specified time); multiplayer cooperation gameplay (for example, a multiplayer heart gesture task, or the like).

For each shooting task, the terminal device displays the task information and a shooting button of the shooting task to the first user. By pressing the shooting button by the user, the terminal device shoots a picture aimed at by a camera.

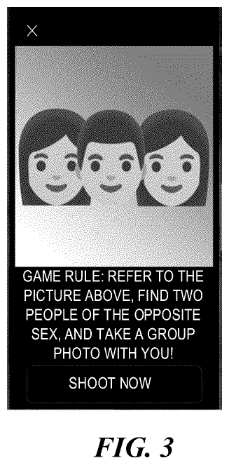

The task information may be displayed as at least one of: a text, a picture, and a video. As an example, FIG. 3 is an example diagram of a further task interface provided in the embodiments of the present disclosure. As shown in FIG. 3, the task information is displayed in a form of a picture plus a text. The picture shows a group photo of 1 male and 2 female. The text displays a task rule which is: “Refer to the picture above, find two people of the opposite sex, and take a group photo with you!”, and “shoot now” in the picture is the shooting button.

The process of obtaining, for each shooting task, the image taken by the first user based on the task information may be as follows: in response to detecting that the first user clicks any shooting task in the shooting task list, controlling a current interface to jump to a task interface where the shooting task is located; receiving a trigger instruction for the shooting button from the first user, shooting a picture aimed at by a camera based on the trigger instruction, and obtaining a shot image.

The task interface is used to display the task information and the shooting button corresponding to the shooting task. The current interface is used to display the shooting task list. The trigger instruction may be implemented through an action operation.

For example, continuing to refer to FIG. 3, as shown in FIG. 3, in addition to displaying images and the task information, a shooting button is also set in the interface. The shooting button is displayed as “Shoot now”, and the trigger instruction for taking a picture may be sent by triggering the button.

In response to the first user clicking on any shooting task in the shooting task list, the terminal device may detect the clicking operation of the first user through detection technology, and the terminal device controls the current interface to jump to the task interface where the shooting task is located. The task interface displays the task information and the shooting button corresponding to the shooting task; the first user triggers the shooting button, and the terminal device receives the trigger instruction for the shooting button from the first user, shoots a picture aimed at by a camera based on the trigger instruction, and obtains a shoot image.

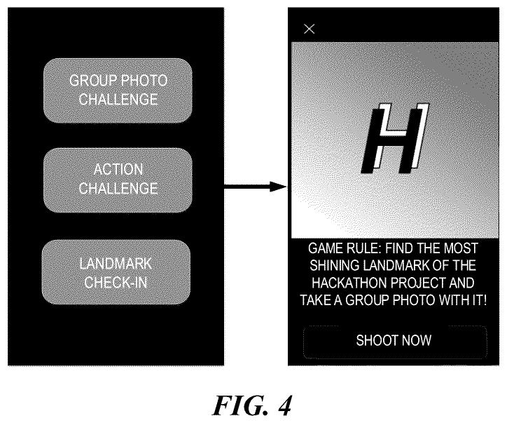

As an example, FIG. 4 is a process diagram of jumping from a task list to a task interface provided in the embodiments of the present disclosure. As shown in FIG. 4, there are three tasks displayed in the task list: a group photo challenge, an action challenge, and landmark check-in. In response to the user clicking the task option of landmark check-in, the terminal device may control the current interface to jump to the task interface where the shooting task is located. As shown in FIG. 4, the task information displayed on the task interface is: “Find the most shining landmark of the Hackathon project and take a group photo with it!”

130: Perform a feature extraction on the image to obtain feature information.

Through image recognition technology, perform the feature extraction on the image taken by the first user based on the task information to obtain the feature information.

The way to perform a feature extraction on the image to obtain feature information may be: inputting the image into a predetermined neural network model to obtain the feature information corresponding to the image.

The feature information comprises at least one of: portrait information, object information, or action information. The predetermined neural network model may be constructed based on any neural network, and may be used to extract features such as portraits, objects, and actions.

140: Compare the feature information with the task information, and determine that the shooting task is completed if the feature information matches the task information.

Compare the similarity between the feature information and the task information, if the similarity between the feature information and the task information meets a similarity condition, the feature information matches the task information, and the shooting task is completed.

For example, the task information is that the participant needs to take a photo with a designated fruit, and the feature information is compared with the task information to determine that the participant has taken a photo with the designated fruit, that is, the feature information matches the task information, and the shooting task is completed.

After the shooting task is completed, the method further comprises:
if all shooting tasks in the shooting task list are completed, obtaining a duration required by the first user to complete all the shooting tasks; and determining a score for the first user based on the duration.

If the first user completes all the shooting tasks in the shooting task list, the duration required by the first user to complete all the shooting tasks is obtained. The duration required by the first user to complete all the shooting tasks may be recorded by the terminal device itself. In response to the terminal device detecting that the task list is displayed on the interface for the first time, a timing module is started for timing. In response to the first user completes all the shooting tasks, the timing ends, so that the duration required by the first user to complete all the shooting tasks may be obtained.

In this embodiment, the duration required by the first user to complete all the shooting tasks is determined as the score for the first user. For example, if the duration required by a user to complete all the shooting tasks is a, the score for the user is a. The shorter the duration required to complete all the shooting tasks, the lower the score for the first user and the higher the game ranking.

In this embodiment, the game organizer may limit the duration to complete the task or not limit the duration to complete the task.

If the game creator limits the duration to complete the task, after the shooting task is completed, the method further comprises:
if the first user completes a part of the shooting tasks within a first predetermined duration, closing all unfinished shooting tasks; obtaining a second predetermined duration corresponding to each unfinished shooting task, determining a duration required by the first user based on the second predetermined duration and the first predetermined duration; and determining a score for the first user based on the duration.

The first predetermined duration may be the longest duration required to complete all the tasks set by the game organizer; the second predetermined duration may be the required duration set by the game organizer for each shooting task. Closing the unfinished shooting tasks may be closing the shooting channel of the unfinished shooting tasks and terminating the timing for the user.

If the first user completes a part of the shooting tasks within the first predetermined duration, which means not all the shooting tasks being completed, then all the unfinished shooting tasks are closed. In this embodiment, in response to the first user completing a part of the shooting tasks within the first predetermined duration, the second predetermined duration corresponding to each unfinished shooting task is obtained, and the first predetermined duration is summed with the second predetermined duration to obtain the duration required by the first user, and the duration is determined as the score for the first user. For example, if the first predetermined duration is b, the second predetermined duration of the unfinished shooting task a is c1, and the second predetermined duration of the unfinished shooting task b is c2, then the duration required by the first user to complete all the shooting tasks is b+c1+c2, and the score for the first user is determined to be a+c1+c2.

After the determining a score for the first user based on the duration, the method further comprises: for a plurality of first users entering the virtual room, ranking the plurality of first users based on the scores; and displaying a result of the ranking.

After determining the score for the first user based on the duration, a plurality of first users in the virtual room may be ranked by the score, and a result of the ranking may be displayed. Relevant rewards or punishments may be given based on the result of the ranking. For example, the shorter the duration, the lower the score, and the higher the ranking.

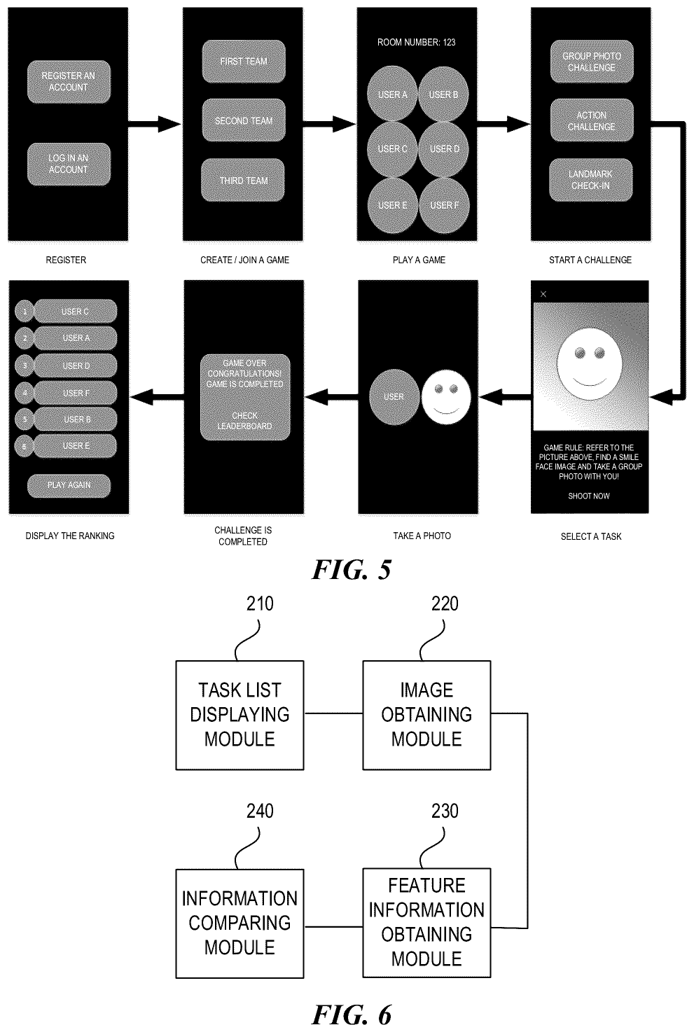

As an example, FIG. 5 is a schematic diagram of an interaction provided in the embodiments of the present disclosure. As shown in FIG. 5, the game organizer or the participant opens an interactive interface, and registers or logs in; the game organizer may create a game, and the game participant may join the game; if the user is a game participant, the user may enter the virtual room by searching for room number 123; select the group photo challenge; the task of the challenge is to find the shown icon to take a group photo; the participant takes a photo and submits it in response to finding the shown item; and the ranking may be viewed after completing the challenge.

Before detecting that the first user enters a virtual room, the method further comprises: receiving a creation instruction triggered by a second user, and creating the virtual room based on the creation instruction; receiving, in the virtual room, a task type selected by the second user and the task information input by the second user; and establishing the shooting task list based on the task type and the task information.

The task information is displayed as at least one of: a text, an image, and a video.

The second user may be the game organizer, and may create the virtual room by triggering the creation instruction and add a corresponding task. The task types here may include various gameplay, including a shooting type of task (for example, an indoor treasure hunting task that connects people and objects, or a task of check-in challenge that connects people and scenery); a video type of task (for example, the user body needs to locate at a designated point on the screen within a specified time); multiplayer cooperation gameplay (for example, a multiplayer heart gesture task). The organizer completes the creation of the room by adding a corresponding game task in the room. The game organizer may visit some large shopping malls, scenic spots, or parks in advance to obtain images or video information in real scenes, set a task rule, and record a shooting task by uploading an image, a video, voice, or a text.

The same second user may create a plurality of virtual rooms, and different second users may create different virtual rooms independently of each other. For example, if an employee of a company wants to use this game for team building, a plurality of virtual rooms may be created. The employees may be divided into several groups, and they may enter different virtual rooms respectively. Alternatively, if employees of a plurality of companies want to use this game for team building, a plurality of virtual rooms may be created, and employees for each company may enter the virtual room established by their organizer for shooting tasks.

To illustrate the embodiments of the present disclosure, the following describes a process of using the interactive game as a team building project, and the user participating in the team building through the terminal device as an example. For example, the game is presented in the form of a mobile APP.

1) The user opens the mobile app. If the user logs in to the app for the first time, then enters a user registration interface. After the user registers, logs in to the mobile app again.

2) If the user already has a mobile APP account, log in to the game homepage and choose a team building identity. There are two identities to choose from: the organizer or the participant.

3) If choosing to be the organizer (that is, the second user mentioned above), create a corresponding team building exclusive room (that is, the virtual room) and add a corresponding task. The task types here may include various gameplay, including a shooting type of task (for example, an indoor treasure hunting task that connects people and objects or a check-in challenge task that connects people and scenery); a video type of task (for example, the user body needs to locate at a designated point on the screen within a specified time); and multiplayer cooperation gameplay (for example, a multiplayer heart gesture task, or the like). The organizer completes the creation of the room by adding a corresponding team building task in the room.

4) If choosing to be a participant (that is, the first user mentioned above), the participant enters the room created by the organizer and take the challenge based on the task set in the room. The terminal device may use the neural network model to judge the challenge of the participant. Taking the indoor treasure hunting task that connects people and objects as an example, the task requires the user to find the specified item within a given time and take a photo to upload. After the participant uploads the shooting result, the terminal device may use the image recognition capability of the neural network model for image recognition. If the user finds the corresponding item, it may determine that the user has completed the task and record the corresponding completion time.

5) The participant completes the task in turn. Determine the duration required by each participant to complete all the shooting tasks based on the completion situation of each participant, thereby determining the score for each participant and ranking them. The organizer may give certain rewards and punishments based on the result of the ranking.

The embodiments of the present disclosure disclose a method, an apparatus, a device, and a storage medium for interaction. In response to detecting that a first user enters a virtual room, display a shooting task list in the virtual room; The shooting task list contains a plurality of shooting tasks, each shooting task carries task information, and the task information corresponds to the target scene; obtain, for the shooting task, an image taken by the first user based on the task information carried by the shooting task; perform a feature extraction on the image to obtain feature information; and compare the feature information with the task information, and determine that the shooting task is completed if the feature information matches the task information. The method of interaction provided in the embodiments of the present disclosure associates the task information with the offline scene. By comparing the feature information of the offline shooting image with the online task information, the shooting task may be completed, and the interaction between the terminal device and the offline scene may be realized. The diversity of interaction patterns with the terminal device may be increased.

FIG. 6 is a schematic diagram of the structure of an apparatus for interaction provided in the embodiments of the present disclosure. As shown in FIG. 6, the apparatus comprises:
a task list displaying module 210 configured to, in response to detecting that a first user enters a virtual room, display a shooting task list in the virtual room; the shooting task list contains a plurality of shooting tasks, and each shooting task carries task information; an image obtaining module configured 220 to obtain, for the shooting task, an image taken by the first user based on the task information carried by the shooting task; a feature information obtaining module 230 configured to perform a feature extraction on the image to obtain feature information; and an information comparing module 240 configured to compare the feature information with the task information, and determine that the shooting task is completed if the feature information matches the task information.

In one embodiment, the image obtaining module 220 is configured to:
in response to detecting that the first user clicks a shooting task in the shooting task list, control a current interface to jump to a task interface where the shooting task is located; wherein the task interface is used to display the task information and a shooting button corresponding to the shooting task; and receive a trigger instruction for the shooting button from the first user, shoot a picture aimed at by a camera based on the trigger instruction, and obtain a shot image.

In one embodiment, the feature information obtaining module 230 is configured to:
input the image into a predetermined neural network model to obtain the feature information corresponding to the image; wherein the feature information comprises at least one of: portrait information, object information, or action information.

In one embodiment, the apparatus further comprises:
a first score determining module configured to, if all shooting tasks in the shooting task list are completed, obtain a duration required by the first user to complete all the shooting tasks; and determine a score for the first user based on the duration.

In one embodiment, the apparatus further comprises:

A second score determining module configured to, if the first user completes a part of the shoot tasks within a first predetermined duration, close all unfinished shooting tasks; obtain a second predetermined duration corresponding to each unfinished shooting task, determine a duration required by the first user based on the second predetermined duration and the first predetermined duration; and determine a score for the first user based on the duration.

In one embodiment, the apparatus further comprises:

A ranking result displaying module configured to, for a plurality of first users entering the virtual room, rank the plurality of first users based on the scores; and display a result of the ranking.

In one embodiment, the apparatus further comprises:
a creation module configured to receive a creation instruction triggered by a second user, and create the virtual room based on the creation instruction; receive, in the virtual room, a task type selected by the second user and the task information input by the second user; wherein the task information is displayed as at least one of a text, an image, or a video; and establish the shooting task list based on the task type and the task information.

The above apparatus may implement the methods provided in all the embodiments of the present disclosure and has the corresponding functional modules and effects for implementing the above methods. Technical details that are not described in detail in this embodiment may be found in the methods provided in all the embodiments of the present disclosure.

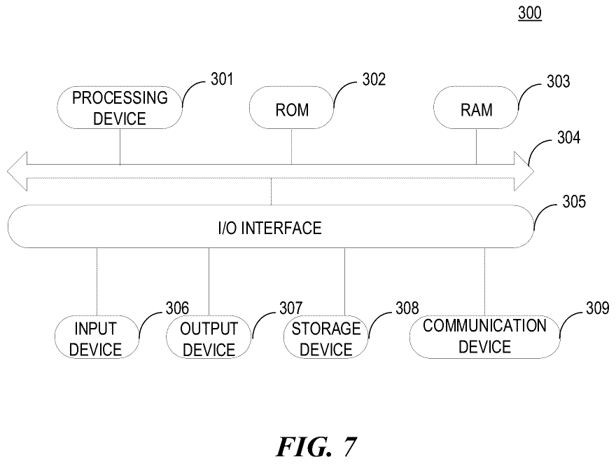

A reference is now made to FIG. 7, which is a schematic diagram of the structure of an electronic device 300 suitable for implementing the embodiments of the present disclosure. The terminal device 300 in the present disclosure may include but is not limited to a mobile terminal such as a mobile phone, a laptop, a digital broadcast receiver, a personal digital assistant (PDA), a tablet computer (Portable Android Device, PAD), a Portable Media Player (PMP), a vehicle-mounted terminal (such as a vehicle navigation terminal), and a fixed terminal such as a digital television (TV), a desktop computer, etc. The electronic device 300 shown in FIG. 7 is only an example and should not bring any restrictions on the functionality and scope of use of the present disclosure.

As shown in FIG. 7, the electronic device 300 may include a processing device (such as a central processing unit and a graphics processor) 301, which may execute various appropriate actions and processing according to a program stored in a read-only memory (ROM) 302 or a program loaded to a random access memory (RAM) 303 from a storage device 308. Various programs and data required during operation of the electronic device 300 are also stored in the RAM 303. The processing device 301, the ROM 302 and the RAM 303 are connected with one another via a bus 304. An input/output (I/O) interface 305 is also connected to the bus 304.

Generally, the following apparatuses may be connected to the I/O interface 305: an input device 306 including for example a touch screen, a touch pad, a keyboard, a mouse, a camera, a microphone, an accelerometer and a gyroscope; an output device 307 including for example a liquid crystal display (LCD), a speaker and a vibrator; a storage device 308 including for example a magnetic tape and a hard disk; and a communication device 309. The communication device 309 may allow wireless or wired communication between the electronic device 300 and other devices for data exchange. Although FIG. 7 shows the electronic device 300 having various devices, it should be understood that not all the devices shown are necessarily required to be implemented or provided. More or fewer devices may alternatively be implemented or provided.

According to the embodiments of the present disclosure, the process described above with reference to the flowcharts may be implemented as a computer software program. For example, an embodiment of the present disclosure provides a computer program product including a computer program carried on a non-transient computer-readable medium. The computer program includes a program code for executing the methods shown in the flowcharts. In such an embodiment, the computer program may be downloaded and installed from the network via the communication device 309, or installed from the storage device 308, or installed from the ROM 302. The computer program, when executed by the processing unit 301, causes the processing unit to execute the above functions defined in the methods according to the embodiments of the present disclosure.

The computer-readable medium according to the present disclosure may be a computer-readable signal medium or a computer-readable storage medium or any combination of the two. The computer-readable storage medium may be, for example, but is not limited to, an electrical, magnetic, optical, electromagnetic, infrared, or semiconductor system, apparatus, or device, or any combination thereof. More specific examples of the computer-readable storage medium include but are not limited to: an electrical connection with at least one wire, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that contains or stores a program. The program may be used by or used in combination with an instruction execution system, apparatus, or device. However, in the present disclosure, the computer-readable signal medium may include a data signal propagated in baseband or as a part of a carrier wave, and computer-readable program code is carried therein. This propagated data signal may take many forms, including but not limited to electromagnetic signals, optical signals, or any suitable combination thereof. The computer-readable signal medium may also be any computer-readable medium other than the computer-readable storage medium. The computer-readable signal medium may send, propagate, or transmit the program used by or used in combination with the instruction execution system, apparatus, or device. The program code contained on the computer-readable medium may be transmitted by any suitable medium, including but not limited to, wire, optical cable, RF, etc., or any suitable combination thereof.

In some implementations, a client and a server may communicate using any currently known or future developed network protocol such as HyperText Transfer Protocol (HTTP) and may interconnect with any form or medium of digital data communication (for example, a communication network). Examples of the communication network include a Local Area Network (LAN), a Wide Area Network (WAN), the Internet network (for example, the Internet), and an end-to-end network (for example, an ad hoc end-to-end network), as well as any currently known or future developed networks.

The computer-readable medium may be included in the electronic device described above; or it may exist alone without being assembled into the electronic device.

The computer-readable medium carries one or more programs, and when the one or more programs are executed by the electronic device, causes the electronic device: in response to detecting that a first user enters a virtual room, to display a shooting task list in the virtual room; wherein the shooting task list contains a plurality of shooting tasks, and each shooting task carries task information; to obtain, for the shooting task, an image taken by the first user based on the task information carried by the shooting task; perform a feature extraction on the image to obtain feature information; and compare the feature information with the task information, and determining that the shooting task is completed if the feature information matches the task information.

The computer program code for performing the operations of the present disclosure may be written in one or more programming languages or a combination thereof, which include but are not limited to object-oriented programming languages Java, Smalltalk, C++, and conventional procedural programming languages such as “C” or similar programming languages. The program codes may be executed completely on a user computer, partially on a user computer, as an independent package, partially on a user computer and partially on a remote computer, or completely on a remote computer or server. In cases involving a remote computer, the remote computer may be connected to a user computer through any type of network, including a local area network (LAN) or a wide area network (WAN), or may be connected to an external computer (for example, through the Internet by using an Internet service provider).

The flowcharts and the block diagrams in the drawings illustrate system architectures, functions and operations that may be implemented based on the system, method and computer program product according to various embodiments of the present disclosure. In this regard, each block in the flowcharts or the block diagrams can represent one module, a program segment or a part of a code, and the module, the program segment or the part of the code includes at least one executable instruction for implementing specific logic functions. It should also be noted that, in some alternative implementations, the functions noted in the blocks may also occur in a sequence different from those illustrated in the drawings. For example, two consecutive blocks may be executed substantially in parallel, and may sometimes be executed in an opposite order, depending on the functions involved. It should also be noted that each block in the block diagrams and/or the flowcharts, and combinations of the blocks in the block diagrams and/or the flowcharts can be implemented in a dedicated hardware-based system that performs the specified functions or operations or can be implemented by the combination of dedicated hardware and computer instructions.

The units described in the embodiments of the present disclosure may be implemented by software or hardware. The name of the unit does not constitute a limitation on the unit itself in one case.

The functions described above herein may be at least partially performed by one or more hardware logic components. For example, non-restrictively, example types of hardware logic components that may be used include: a field programmable gate array (FPGA), an application-specific integrated circuit (ASIC), an application-specific standard parts (ASSP), a system-on-chip (SOC), a complex programmable logic device (CPLD), and the like.

In the context of the present disclosure, the machine-readable medium may be a tangible medium that may contain or store a program used by or used in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination thereof.

According to one or more embodiments of the present disclosure, the present disclosure discloses a method of interaction, and the method comprises:
in response to detecting that a first user enters a virtual room, displaying a shooting task list in the virtual room; wherein the shooting task list contains a plurality of shooting tasks, and each shooting task carries task information;
obtaining, for the shooting task, an image taken by the first user based on the task information carried by the shooting task;
performing a feature extraction on the image to obtain feature information; and
comparing the feature information with the task information, and determining that the shooting task is completed if the feature information matches the task information.

In one embodiment, the obtaining, for the shooting task, an image taken by the first user based on the task information carried by the shooting task comprises:
in response to detecting that the first user clicks a shooting task in the shooting task list, controlling a current interface to jump to a task interface where the shooting task is located; wherein the task interface is used to display the task information and a shooting button corresponding to the shooting task; and
receiving a trigger instruction for the shooting button from the first user, shooting a picture aimed at by a camera based on the trigger instruction, and obtaining a shot image.

In one embodiment, the performing a feature extraction on the image to obtain feature information comprises:
inputting the image into a predetermined neural network model to obtain the feature information corresponding to the image; wherein the feature information comprises at least one of: portrait information, object information, or action information.

In one embodiment, after the shooting task is completed, the method further comprising:
if all shooting tasks in the shooting task list are completed, obtaining a duration required by the first user to complete all the shooting tasks; and
determining a score for the first user based on the duration.

In one embodiment, after the shooting task is completed, the method further comprising:
if the first user completes a part of the shooting tasks within a first predetermined duration, closing all unfinished shooting tasks;
obtaining a second predetermined duration corresponding to each unfinished shooting task, determining a duration required by the first user based on the second predetermined duration and the first predetermined duration; and
determining a score for the first user based on the duration.

In one embodiment, after the determining a score for the first user based on the duration, the method further comprising:
for a plurality of first users entering the virtual room,
ranking the plurality of first users based on the scores; and
displaying a result of the ranking.

In one embodiment, before the detecting that a first user enters a virtual room, the method further comprising:
receiving a creation instruction triggered by a second user, and creating the virtual room based on the creation instruction;
receiving, in the virtual room, a task type selected by the second user and the task information input by the second user; wherein the task information is displayed as at least one of a text, an image, or a video; and
establishing the shooting task list based on the task type and the task information.

1-11. (canceled)

12. A method for interaction, comprising:
in response to detecting that a first user enters a virtual room, displaying a shooting task list in the virtual room; wherein the shooting task list contains a plurality of shooting tasks, and a shooting task of the plurality of shooting tasks carries task information;
obtaining, for the shooting task, an image taken by the first user based on the task information carried by the shooting task;
performing a feature extraction on the image to obtain feature information; and
comparing the feature information with the task information, and determining that the shooting task is completed if the feature information matches the task information.

13. The method of claim 12, wherein the obtaining, for the shooting task, an image taken by the first user based on the task information carried by the shooting task comprises:
in response to detecting that the first user clicks a shooting task in the shooting task list, controlling a current interface to jump to a task interface where the shooting task is located; wherein the task interface is used to display the task information and a shooting button corresponding to the shooting task; and
receiving a trigger instruction for the shooting button from the first user, shooting a picture aimed at by a camera based on the trigger instruction, and obtaining a shot image.

14. The method of claim 12, wherein the performing a feature extraction on the image to obtain feature information comprises:
inputting the image into a predetermined neural network model to obtain the feature information corresponding to the image; wherein the feature information comprises at least one of: portrait information, object information, or action information.

15. The method of claim 12, after the shooting task is completed, the method further comprising:
if all shooting tasks in the shooting task list are completed, obtaining a duration required by the first user to complete all the shooting tasks; and
determining a score for the first user based on the duration.

16. The method of claim 12, after the shooting task is completed, the method further comprising:
if the first user completes a part of the shooting tasks within a first predetermined duration, closing all unfinished shooting tasks;
obtaining a second predetermined duration corresponding to each unfinished shooting task, determining a duration required by the first user based on the second predetermined duration and the first predetermined duration; and
determining a score for the first user based on the duration.

17. The method of claim 15, after the determining a score for the first user based on the duration, the method further comprising:
for a plurality of first users entering the virtual room,
ranking the plurality of first users based on the scores; and
displaying a result of the ranking.

18. The method of claim 12, before the detecting that a first user enters a virtual room, the method further comprising:
receiving a creation instruction triggered by a second user, and creating the virtual room based on the creation instruction;
receiving, in the virtual room, a task type selected by the second user and the task information input by the second user; wherein the task information is displayed as at least one of a text, an image, or a video; and
establishing the shooting task list based on the task type and the task information.

19. An electronic device comprising:
at least one processing device;
a storage device configured to store at least one program;
the at least one program, when executed by the at least one processing device, causes the at least one processing device to perform acts comprising:
in response to detecting that a first user enters a virtual room, displaying a shooting task list in the virtual room; wherein the shooting task list contains a plurality of shooting tasks, and a shooting task of the plurality of shooing tasks carries task information;
obtaining, for the shooting task, an image taken by the first user based on the task information carried by the shooting task;
performing a feature extraction on the image to obtain feature information; and
comparing the feature information with the task information, and determining that the shooting task is completed if the feature information matches the task information.

20. The electronic device of claim 19, wherein the obtaining, for the shooting task, an image taken by the first user based on the task information carried by the shooting task comprises:
in response to detecting that the first user clicks a shooting task in the shooting task list, controlling a current interface to jump to a task interface where the shooting task is located; wherein the task interface is used to display the task information and a shooting button corresponding to the shooting task; and
receiving a trigger instruction for the shooting button from the first user, shooting a picture aimed at by a camera based on the trigger instruction, and obtaining a shot image.

21. The electronic device of claim 19, wherein the performing a feature extraction on the image to obtain feature information comprises:
inputting the image into a predetermined neural network model to obtain the feature information corresponding to the image; wherein the feature information comprises at least one of: portrait information, object information, or action information.

22. The electronic device of claim 19, after the shooting task is completed, the acts further comprising:
if all shooting tasks in the shooting task list are completed, obtaining a duration required by the first user to complete all the shooting tasks; and
determining a score for the first user based on the duration.

23. The electronic device of claim 19, after the shooting task is completed, the acts further comprising:
if the first user completes a part of the shooting tasks within a first predetermined duration, closing all unfinished shooting tasks;
obtaining a second predetermined duration corresponding to each unfinished shooting task, determining a duration required by the first user based on the second predetermined duration and the first predetermined duration; and
determining a score for the first user based on the duration.

24. The electronic device of claim 22, after the determining a score for the first user based on the duration, the acts further comprising:
for a plurality of first users entering the virtual room,
ranking the plurality of first users based on the scores; and
displaying a result of the ranking.

25. The electronic device of claim 19, before the detecting that a first user enters a virtual room, the acts further comprising:
receiving a creation instruction triggered by a second user, and creating the virtual room based on the creation instruction;
receiving, in the virtual room, a task type selected by the second user and the task information input by the second user; wherein the task information is displayed as at least one of a text, an image, or a video; and
establishing the shooting task list based on the task type and the task information.

26. A computer-readable medium storing a computer program, wherein the program, when executed by a processing device, performs acts comprising:
in response to detecting that a first user enters a virtual room, displaying a shooting task list in the virtual room; wherein the shooting task list contains a plurality of shooting tasks, and a shooting task of the plurality of shooting tasks carries task information;
obtaining, for the shooting task, an image taken by the first user based on the task information carried by the shooting task;
performing a feature extraction on the image to obtain feature information; and
comparing the feature information with the task information, and determining that the shooting task is completed if the feature information matches the task information.

27. The computer-readable medium of claim 26, wherein the obtaining, for the shooting task, an image taken by the first user based on the task information carried by the shooting task comprises:
in response to detecting that the first user clicks a shooting task in the shooting task list, controlling a current interface to jump to a task interface where the shooting task is located; wherein the task interface is used to display the task information and a shooting button corresponding to the shooting task; and
receiving a trigger instruction for the shooting button from the first user, shooting a picture aimed at by a camera based on the trigger instruction, and obtaining a shot image.

28. The computer-readable medium of claim 26, wherein the performing a feature extraction on the image to obtain feature information comprises:
inputting the image into a predetermined neural network model to obtain the feature information corresponding to the image; wherein the feature information comprises at least one of: portrait information, object information, or action information.

29. The computer-readable medium of claim 26, after the shooting task is completed, the acts further comprising:
if all shooting tasks in the shooting task list are completed, obtaining a duration required by the first user to complete all the shooting tasks; and
determining a score for the first user based on the duration.

30. The computer-readable medium of claim 26, after the shooting task is completed, the acts further comprising:
if the first user completes a part of the shooting tasks within a first predetermined duration, closing all unfinished shooting tasks;
obtaining a second predetermined duration corresponding to each unfinished shooting task, determining a duration required by the first user based on the second predetermined duration and the first predetermined duration; and
determining a score for the first user based on the duration.

31. The computer-readable medium of claim 29, after the determining a score for the first user based on the duration, the acts further comprising:
for a plurality of first users entering the virtual room,
ranking the plurality of first users based on the scores; and
displaying a result of the ranking.
